(19) United States
(12) Patent Application Publication
(10) Pub. No.: US 2008/0036351 A1
(43) Pub. Date: Feb. 14, 2008

(54) Incandescent Lamp With an Absorption and Interference Filter

(75) Inventors: Sigbert Muller, Neusass (DE); Reinhard Schafer, Heidenheim (DE)

Correspondence Address: OSRAM SYLVANIA INC, 100 ENDICOTT STREET, DANVERS, MA, 01923, US

(73) Assignee: PATENT-TREUHAND-GESSELLSCHAFT FUR ELEKTRISCHE GLUHLAMPEN MBH, Munchen (DE)

(21) Appl. No.: 11/665,329

(22) PCT Filed: Nov. 11, 2005
(86) PCT No.: PCT/DE05/02032

§ 371 Date: May 29, 2007

(30) Foreign Application Priority Data
Nov. 15, 2004 (DE) 10 2004 055 081.6

(51) Int. Cl. H01K 1/28

(52) U.S. Cl. 313/112

(57) ABSTRACT

The invention relates to an incandescent lamp for producing light in a red region of the spectrum, comprising: a translucent lamp bulb (4); a spiral-wound filament enclosed by the lamp bulb, and; an interference filter (8), which is placed on the lamp bulb and which has a number of optically low refractive layers and optically highly refractive layers. According to the invention, the lamp bulb itself forms an absorption filter that absorbs unwanted light spectra. The color location shift into the red region of the spectrum ensues via the interference filter.

### TECHNICAL FIELD

The invention relates to an incandescent lamp in accordance with the preamble of patent claim 1.

### PRIOR ART

Such incandescent lamps are used, for example, in the field of vehicle technology as light source for tail lights, brake light fittings, tail fog light fittings and the like. Use is frequently made for these red emitting light fittings of incandescent lamps whose lamp vessel has a heat resistant oxidic interference filter coating with integrated absorber layers for absorbing unwanted blue and violet light spectra. The layer thickness of the interference filter coating is adapted in such a way that all the regions of the coated lamp vessel emit light of the same red color spectrum during operation of the incandescent lamp.

Such an incandescent lamp is disclosed, for example, in German laid-open application EP 0 986 093 A1. This incandescent lamp uses an interference filter with thin absorber layers that partially absorb unwanted shortwave light in the blue and violet spectral regions. An interference coating of the interference filter consisting of optically low-index and optically high-index layers serves the purpose of further suppression of light from the violet, blue and green spectral regions, and for setting the filter edge of the interference filter in the red spectral region. One disadvantage with such incandescent lamps is that because of the color values prescribed by law for vehicle lighting, and the requisite wide reflection band with a steep transmission edge, it is necessary to apply to the lamp vessel very many layer sequences in a number of layer stacks made from different layer materials, that is to say made from interference and absorption layers. The coating process used in producing such incandescent lamps is complicated and cost intensive because of the large number of requisite layers and layer materials—said interference filter consists, for example, of five layer stacks with three layer materials and 28 layers.

### SUMMARY OF THE INVENTION

It is the object of the invention to provide an incandescent lamp that by contrast with conventional solutions enables a simplified layer structure in conjunction with a reduced production outlay.

This object is achieved according to the invention by the features of claim 1. Particularly advantageous designs of the invention are described in the dependent claims.

The incandescent lamp according to the invention for producing light in a red spectral region has a transparent lamp vessel that surrounds an incandescent filament, and an interference filter that is arranged on the lamp vessel and has a number of optically low-index and optically high-index layers. According to the invention, the lamp vessel itself forms an absorption filter that absorbs unwanted light spectra, the color locus displacement into the desired red spectral region being performed by the interference filter. By contrast with the prior art, forming the lamp vessel as absorption filter requires no additional absorber layers arranged in the interference filter, that is to say the interference layer stack can consist of two instead of three layer materials, and have a reduced number of layers. This results in a simplification of the layer structure in conjunction with a reduced production outlay. Unwanted blue-green scattered light, which can occur in production engineering and technical application situations, is prevented by the formation of the lamp vessel as absorption filter in the shortwave spectral region.

The lamp vessel preferably consists of lamp glass that emits yellowish to amber-colored light.

In the switched-off state, sunlight transilluminates the yellowish to amber-colored lamp vessel. The application of a pure absorption filter leads in the headlamp to the so-called “fried egg effect”. However, the interference filter applied to the lamp vessel additionally reflects violet, blue, green and yellow sunlight. The transmitted red color mixes together with the reflected violet, blue, green and yellow colors to form white. The external appearance of the incandescent lamp in the switched-off state is neutral, and so it can be used for color neutral light fitting applications.

In accordance with a preferred exemplary embodiment, the lamp vessel of the inventive incandescent lamp consists of thoroughly colored and/or coated lamp glass and as a result absorbs the unwanted light spectra.

In the case of a further embodiment, the lamp vessel is coated with a thermostable coating, in particular with amber paint or a sol-gel absorption filter. The coating with amber-colored sol-gel or paint that absorbs the unwanted violet, blue to greenish wavelength regions, can be performed by means of coating methods known from the general prior art, for example by spraying or dipping.

It has proven advantageous to design the absorption filter in such a way that violet, blue and/or green wavelength regions are absorbed by the lamp vessel.

The interference filter is preferably formed from a single layer stack that is arranged on the lamp vessel and is made from optically low-index layers and optically high-index layers, and consists of two materials.

In a preferred exemplary embodiment, the optically low-index layers are SiO₂ layers and the optically high-index layers are Nb₂O₅ or TiO₂ layers. The layer stack is advantageously formed from 13, 15 or 17 layers.

The optically low-index layers preferably have a layer thickness of essentially 90 nm±15% and the optically high-index layers have a layer thickness of essentially 52 nm±15% or 46 nm±15%, and are alternatingly arranged in the layer stack.

The layer stack is preferably begun and terminated by an optically high-index layer with a layer thickness of 26 nm±15% and 23 nm±15%, respectively.

The optically low index and optically high-index layers can also be applied in a relatively large layer thickness mismatch.

The layer thicknesses of the optically low index and optically high-index layers of the layer stack are preferably optimized in such a way that the filter edge of the interference filter lies in the red spectral region, in particular in a wavelength region of 580 nm to 640 nm, preferably at 597 nm. This ensures that the inventive incandescent lamp emits substantially a light spectrum in accordance with the ECE color standard and fulfils the statutory color values for vehicle illumination, in particular for brake lamps, tail lamps and/or tail fog lamps and the like.

The interference filter is preferably arranged with a locally different layer thickness on the lamp vessel as a function of the angle of incidence of the light emitted by the incandescent filament and impinging on the interference filter.

### BRIEF DESCRIPTION OF THE DRAWINGS

The invention is explained in more detail below with the aid of a preferred exemplary embodiment. In the drawing:

FIG. 1 shows a side view of an incandescent lamp in accordance with the preferred exemplary embodiment of the invention, and

FIG. 2 shows transmission curves of the absorption filter and the interference filter coating.

### PREFERRED EMBODIMENT OF THE INVENTION

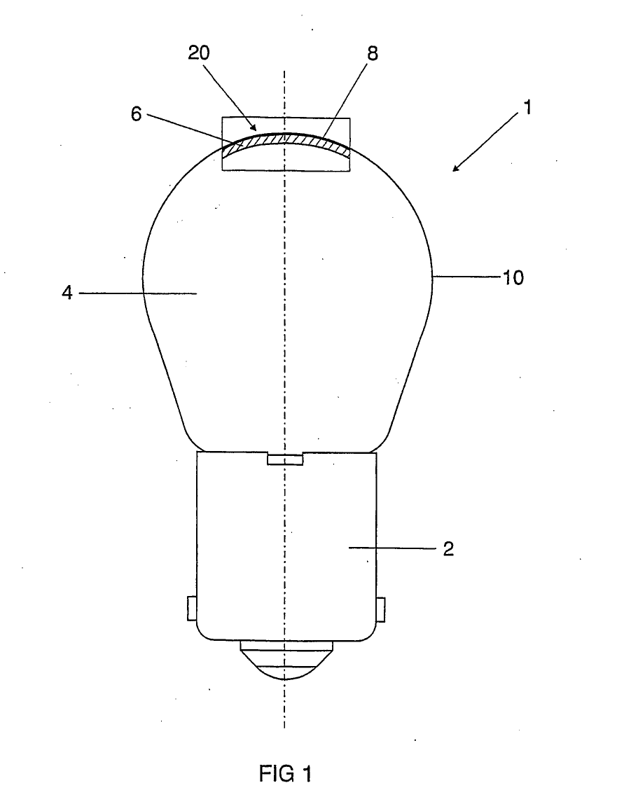

FIG. 1 shows an incandescent lamp 1 for producing light in a red spectral region, having an electric power consumption of approximately 25 W, that is used, for example, as light source in the tail light fitting of a vehicle in order to produce tail light, brake light or tail fog light. This incandescent lamp 1 has a bayonet-type lamp base 2 and a lamp vessel 4, made from thoroughly colored lamp glass 6, that is rotationally symmetrical about a lamp axis A-A and surrounds an incandescent filament (not illustrated). According to the invention, the lamp vessel 4 made from thoroughly colored lamp glass 6 forms an absorption filter that absorbs unwanted light spectra, for example blue-green scattered light, the color locus displacement into the desired red spectral region being performed by an interference filter coating 8. To this end, the entire outer surface 10 of the lamp vessel 4 is provided with the interference filter coating 8, which has a number of optically low-index and optically high-index layers that are applied using a sputtering technique. The layer thickness is controlled via the duration of the sputtering process, the process gas feed and the feeding in of electric power. The formation of the lamp vessel 4 as absorption filter means, by contrast with the prior art, that the interference filter coating 8 does not require additional absorber layers arranged between the interference layers. Consequently, the interference layer stack can be constructed from two instead of three, as required in the prior art in accordance with EP 0 986 093 A1, layer materials, the result being to simplify the layer structure considerably in conjunction with a reduced outlay on production. This will be explained in more detail below.

In accordance with table 1 or an alternative embodiment in accordance with table 2, the interference filter coating 8 consists of a total of 15 interference layers that, by contrast with the prior art, are arranged in a single layer stack and without absorber layers in a fashion beginning with layer No. 1 on the outer surface 10 of the lamp vessel 4.

TABLE 1
Structure of the interference filter coating

| | | Approx. layer |
|---|---|---|
| Layer No. | Type of layer | thickness [nm] |
| 1 | Nb₂O₅ | 26 |
| 2 | SiO₂ | 90 |
| 3 | Nb₂O₅ | 52 |
| 4 | SiO₂ | 90 |
| 5 | Nb₂O₅ | 52 |
| 6 | SiO₂ | 90 |
| 7 | Nb₂O₅ | 52 |
| 8 | SiO₂ | 90 |
| 9 | Nb₂O₅ | 52 |
| 10 | SiO₂ | 90 |
| 11 | Nb₂O₅ | 52 |
| 12 | SiO₂ | 90 |
| 13 | Nb₂O₅ | 52 |
| 14 | SiO₂ | 90 |
| 15 | Nb₂O₅ | 26 |

TABLE 2
Structure of the interference filter coating

| | | Approx. layer |
|---|---|---|
| Layer No. | Type of layer | thickness [nm] |
| 1 | TiO₂ | 23 |
| 2 | SiO₂ | 90 |
| 3 | TiO₂ | 46 |
| 4 | SiO₂ | 90 |
| 5 | TiO₂ | 46 |
| 6 | SiO₂ | 90 |
| 7 | TiO₂ | 46 |
| 8 | SiO₂ | 90 |
| 9 | TiO₂ | 46 |
| 10 | SiO₂ | 90 |
| 11 | TiO₂ | 46 |
| 12 | SiO₂ | 90 |
| 13 | TiO₂ | 46 |
| 14 | SiO₂ | 90 |
| 15 | TiO₂ | 23 |

The layer stack is formed in an alternating fashion from optically low-index and optically high-index layers, the optically low-index layers being SiO₂ (silicon dioxide), and the optically high-index layers in accordance with Table 1 being Nb₂O₅ (niobium pentoxide) or, in accordance with Table 2, TiO₂ (titanium dioxide). The layers 1 to 15 follow one another directly and form the interference coating 8.

The physical layer thickness of the SiO₂ layers and the Nb₂O₅ layers or TiO₂ layers, and thus also the total layer thickness of the interference filter coating 8 varies as a function of location such that all the regions of the lamp vessel 4 emit light of a uniform color composition. As a function of the angle of incidence of the light emitted by the incandescent filament and impinging on the interference filter 8, this requires a steady increase in the total layer thickness of the interference filter 8, starting from a lamp vessel dome 20, along the shortest connecting line on the lamp vessel 4 in the direction of the lamp base 2, that is to say the layer thickness of the interference filter 8 varies locally as a function of the angle of incidence of the light emitted by the incandescent filament and impinging on the interference filter 8, the difference between the smallest and the greatest layer thickness being approximately 7 per cent. The layer thickness data of the interference filter coating 8 that has been named in this exemplary embodiment respectively relates to the dome 20 of the lamp vessel 4. The layer thickness of the interference filter 8 is constant along concentric rings about the lamp axis A-A.

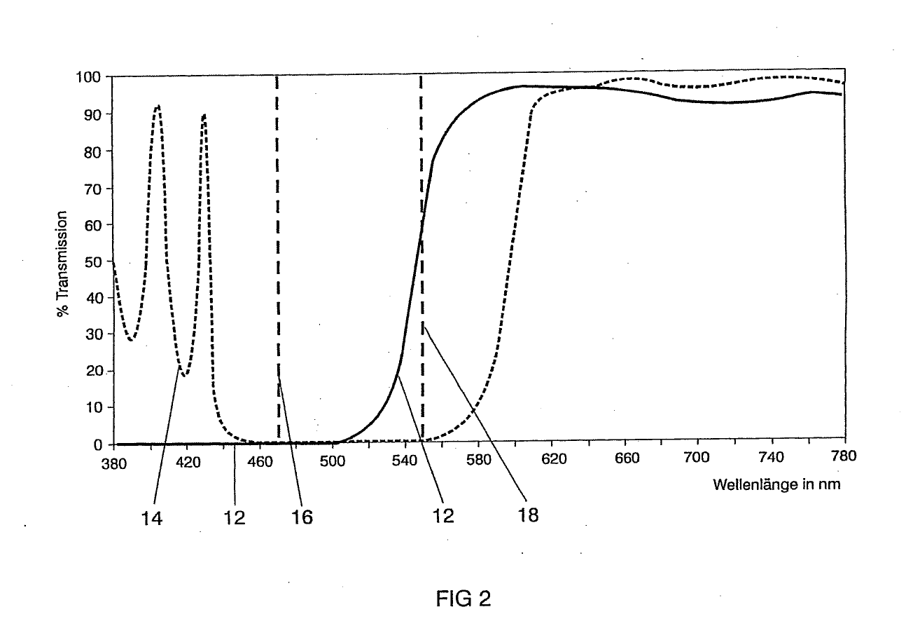

In FIG. 2, the transmission response of the absorption filter is illustrated by a curve 12, and the transmission response of the interference filter by a curve 14 indicated by dashes. In accordance with curve 12, the absorption filter of the lamp vessel 4 is formed in such a way that unwanted violet, blue and, to some extent, green wavelength regions are absorbed by the colored lamp glass 6, that is to say the transmission oscillation of the curve 14 of the interference filter coating 8 in the region of approximately 380 nm to 460 nm is superimposed by the absorption activity of the lamp glass 6, which would otherwise need to be suppressed by the interference filter coating 8. It is possible in this way to make use of an interference filter with a reduced number of layers by comparison with the prior art. The tolerance band of color fluctuations in the lamp glass 6, and thus the limits of the edge positions 16, 18 of the absorption filter can be designed to be between the unwanted color spectra in the shortwave region and the good transmission in the red region, that is to say to be relatively wide. In accordance with FIG. 2, the lower limit 16 of the edge position of the absorption filter lies at a wavelength of approximately 470 nm, and the upper limit 18 of the edge position of the absorption filter lies at a wavelength of approximately 550 nm.

According to the invention, the color locus displacement from the yellow/amber spectral region into the desired red spectral region is performed by the interference filter coating 8, that is to say the filter edge of the interference filter on which the transmission of the interference filter is fifty per cent of the incident light lies at approximately 600 nm in accordance with FIG. 2. Consequently, in the switched-on state, the incandescent lamp 1 emits red light and can be used as light source for brake light fittings, tail light fittings or tail fog light fittings.

The invention is not restricted to the exemplary embodiment explained in more detail above; in particular, the invention can be applied to incandescent lamps of any desired lamp vessel geometry and with a different interference filter design. Instead of the thoroughly colored lamp vessel, it is possible to apply a thermostable coating, in particular a paint as absorption filter to the lamp glass. Moreover, the invention can also be designed with another number of optically low-index and optically high-index layers. Furthermore, other suitable materials and coating processes can be used for the interference layers.

An incandescent lamp 1 is disclosed for producing light in a red spectral region having a transparent lamp vessel 4, an incandescent filament surrounded by the lamp vessel 4, and an interference filter 8 that is arranged on the lamp vessel 4 and has a number of optically low-index and optically high-index layers. According to the invention, the lamp vessel 4 itself forms an absorption filter that absorbs unwanted light spectra, and the color locus displacement into the red spectral region is performed by the interference filter 8.

1. An incandescent lamp for producing light in a red spectral region, having a transparent lamp vessel (4), an incandescent filament surrounded by the lamp vessel (4), and an interference filter (8) that is arranged on the lamp vessel (4) and has a number of optically low-index and optically high-index layers, characterized in that the lamp vessel (4) forms an absorption filter that absorbs unwanted light spectra, and the color locus displacement into the red spectral region is performed by the interference filter (8).

2. The incandescent lamp as claimed in claim 1, in which the absorption filter of the lamp vessel (4) is formed in such a way that violet, blue and/or green wavelength regions are absorbed by the lamp vessel (4).

3. The incandescent lamp as claimed in claim 1, in which the lamp vessel (4) consists of thoroughly colored and/or coated lamp glass (6).

4. The incandescent lamp as claimed in claim 3, in which the lamp vessel (4) is coated with a thermostable coating, in particular amber paint or a sol-gel absorption filter.

5. The incandescent lamp as claimed in claim 3, in which during operation the lamp glass (6) emits yellowish or amber-colored light.

6. The incandescent lamp as claimed in claim 1, in which the interference filter (8) is formed from a single layer stack of the optically low-index layers and optically high-index layers, and consists of two materials.

7. The incandescent lamp as claimed in claim 6, in which the optically low-index layers are SiO₂ layers and the optically high-index layers are Nb₂O₅ or TiO₂ layers.

8. The incandescent lamp as claimed in claim 6, in which the optically low-index layers essentially have a layer thickness of 90 nm±15% and the optically high-index layers have a layer thickness of 52 nm±15% or 46 nm±15%, and are alternatingly arranged.

9. The incandescent lamp as claimed in claim 6, in which the layer stack is begun and terminated by an optically high-index layer with a layer thickness of 26 nm±15% and 23 nm±15%, respectively.

10. The incandescent lamp as claimed in claim 6, in which the layer stack is optimized in such a way that the filter edge of the interference filter (8) lies in the red spectral region, in particular in a wavelength region of 580 nm to 640 nm, preferably at 597 nm.

11. The incandescent lamp as claimed in claim 6, in which the layer stack has 13, 15 or 17 layers.

12. The incandescent lamp as claimed in claim 1, in which the interference filter (8) is arranged with a locally different layer thickness on the lamp vessel (4) as a function of the angle of incidence of the light emitted by the incandescent filament and impinging on the interference filter (8).

13. The incandescent lamp as claimed in claim 1, in which the lamp emits a light spectrum in accordance with the ECE standard for brake lamps, tail lamps and/or tail fog lamps.

14. The incandescent lamp as claimed in claim 2, in which the lamp vessel (4) consists of thoroughly colored and/or coated lamp glass (6).

15. The incandescent lamp as claimed in claim 7, in which the optically low-index layers essentially have a layer thickness of 90 nm±15% and the optically high-index layers have a layer thickness of 52 nm±15% or 46 nm±15%, and are alternatingly arranged.

16. The incandescent lamp as claimed in claim 7, in which the layer stack is optimized in such a way that the filter edge of the interference filter (8) lies in the red spectral region, in particular in a wavelength region of 580 nm to 640 nm, preferably at 597 nm.

17. The incandescent lamp as claimed in claim 8, in which the layer stack is optimized in such a way that the filter edge of the interference filter (8) lies in the red spectral region, in particular in a wavelength region of 580 nm to 640 nm, preferably at 597 nm.

18. The incandescent lamp as claimed in claim 9, in which the layer stack is optimized in such a way that the filter edge of the interference filter (8) lies in the red spectral region, in particular in a wavelength region of 580 nm to 640 nm, preferably at 597 nm.
